(19) United States
(12) Patent Application Publication
(10) Pub. No.: US 2011/0025117 A1
(43) Pub. Date: Feb. 3, 2011

(54) Universal Tailgate Assembly

(76) Inventor: Robert S. Williams, III, Williamsburg, VA (US)

Correspondence Address: Heidi Faivre, PO BOX 5743, WILLIAMSBURG, VA, 23188, US

(21) Appl. No.: 12/846,137

(22) Filed: Jul. 29, 2010

Related U.S. Application Data
(60) Provisional application No. 61/273,018, filed on Jul. 29, 2009.

(51) Int. Cl. B60P 1/26; B60P 1/04; B62D 33/027

(52) U.S. Cl. 298/23 R; 296/56

(57) ABSTRACT

An exemplary embodiment provides a universal tailgate assembly for a truck dump body having a pair of opposing sidewalls and an open rear-end. The universal tailgate assembly comprises a pair of pivot connector assemblies being configured to mount to the sidewalls of the truck dump body and a pair of opposing sidearms configured to adjustably couple thereto the pair of pivot connector assemblies. Each sidearm includes a connection flange oriented in a direction opposite a respective adjacent sidewall of the truck dump body. The assembly includes a tailgate supported by the pair of opposing sidearms. The tailgate has a center portion and extension sections on opposing sides of the center portion. A respective one extension section is adjustably coupled to and overlapping the connection flange of a corresponding sidearms wherein the extension sections extend beyond the sidewalls of the truck dump body.

### COPENDING APPLICATIONS

This application claims priority benefit of Provisional Patent Application No. 61/273,018, filed Jul. 29, 2009, titled “TAILGATE ASSEMBLY” having the same inventor and which is incorporated herein by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The invention relates to tailgates for articulated trucks or dump trucks. Dump trucks are available in a variety of shapes and sizes and are referred to using a variety of terms including excavator trucks, articulated trucks, mining trucks, and other names. Some of these dump trucks are sold without a tailgate. Thus, the tailgates are generally customized to fit the exact dimensions of the rear end of the truck dump body, and such customization is time consuming and costly. Thus, there is a need for a universal tailgate assembly that can be used for rear ends of various dump truck body sizes and shapes.

### SUMMARY

The aforementioned problems, and other problems, are reduced, according to exemplary embodiments, by the universal tailgate assembly for dump trucks described herein below. According to some of the embodiments of this invention, a universal tailgate assembly design is proposed. There is a need for a universal tailgate assembly configured with three directions of adjustment to accommodate a variety of truck dump body sizes. One direction of adjustment includes an up-down adjustment (vertical adjustment) in the arm-to-gate connection. A second direction of adjustment includes a width adjustment in the arm-to-gate connection. A third direction of adjustment includes a (front-back) horizontal adjustment at the pivot connection between the arm and the articulated truck.

An exemplary embodiment provides a universal tailgate assembly for a truck dump body having a pair of opposing sidewalls and an open rear-end. The universal tailgate assembly comprises a pair of pivot connector assemblies being configured to mount to the sidewalls of the truck dump body and a pair of opposing sidearms configured to adjustably couple thereto the pair of pivot connector assemblies. Each sidearm includes a connection flange oriented in a direction opposite a respective adjacent sidewall of the truck dump body. The assembly includes a tailgate supported by the pair of opposing sidearms. The tailgate has a center portion and extension sections on opposing sides of the center portion. A respective one extension section is adjustably coupled to and overlapping the connection flange of a corresponding sidearm wherein the extension sections extend beyond the sidewalls of the truck dump body.

Another exemplary embodiment provides a universal tailgate assembly for a truck dump body having a pair of opposing sidewalls and an open rear-end. The universal tailgate assembly comprises a pair of sidearms pivotally mounted to the truck dump body. The assembly also includes a tailgate adjustably mounted to the pair of sidearms via opposing arm-to-gate connections, the opposing arm-to-gate connections include means for adjusting the tailgate vertically in relation to the pair of sidearms and means for adjusting a width between the opposing arm-to-gate connections for connection of the tailgate to the pair of sidearms in relation to the truck dump body.

Another embodiment provides an articulated truck comprising a truck having a truck dump body, the truck dump body includes a pair of opposing sidewalls and an open rear-end; and a universal tailgate assembly. The universal tailgate assembly comprises a pair of sidearms pivotally mounted to the truck dump body. The assembly also includes a tailgate adjustably mounted to the pair of sidearms via opposing arm-to-gate connections, the opposing arm-to-gate connections include means for adjusting the tailgate vertically in relation to the pair of sidearms and means for adjusting a width between the opposing arm-to-gate connections for connection of the tailgate to the pair of sidearms in relation to the truck dump body.

The universal tailgate assembly is adaptable for various articulated dump truck models by various manufacturers such as without limitation Caterpillar (CAT) 725, CAT 730, CAT 735, CAT 740, CAT 745, Volvo A25D, Volvo A25E, Volvo A35D, Volvo A35E, Volvo A40E, Volvo A40D, John Deere, Komatsu, Case, Moxy, and Bell. Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The exemplary embodiments, objects, uses, advantages, and novel features are more clearly understood by reference to the following description taken in connection with the accompanying figures wherein:

FIG. 1A illustrates a side view of the universal tailgate assembly installed on a truck dump body in accordance with some exemplary embodiments of the invention;

FIG. 1B illustrates a rear view of the universal tailgate assembly installed on a truck dump body in accordance with some exemplary embodiments of the invention;

FIG. 2A illustrates an exploded view of the universal tailgate assembly in accordance with some exemplary embodiments of the invention;

FIG. 2B illustrates a top view of the universal tailgate assembly of FIG. 2A in accordance with some exemplary embodiments of the invention;

FIG. 2C illustrates a cross-sectional view along the plane 2C-2C of FIG. 2D;

FIG. 2D illustrates a side view of the universal tailgate assembly of FIG. 2A in accordance with some exemplary embodiments of the invention;

FIG. 2E illustrates a rear view of the universal tailgate assembly of FIG. 2A in accordance with some exemplary embodiments of the invention;

FIG. 2F illustrates an exploded view of the sidearm of FIG. 2A in accordance with some exemplary embodiments of the invention;

FIG. 3A illustrates an exploded view of another universal tailgate assembly in accordance with some exemplary embodiments of the invention;

FIG. 3B illustrates a top view of the universal tailgate assembly of FIG. 3A in accordance with some exemplary embodiments of the invention;

FIG. 3C illustrates a cross-sectional view along the plane 3C-3C of FIG. 3D;

FIG. 3D illustrates a side view of the universal tailgate assembly of FIG. 3A in accordance with some exemplary embodiments of the invention;

FIG. 3E illustrates a rear view of the universal tailgate assembly of FIG. 3A in accordance with some exemplary embodiments of the invention; and

FIG. 3F illustrates an exploded view of the sidearm of FIG. 3A in accordance with some exemplary embodiments of the invention.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill in the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

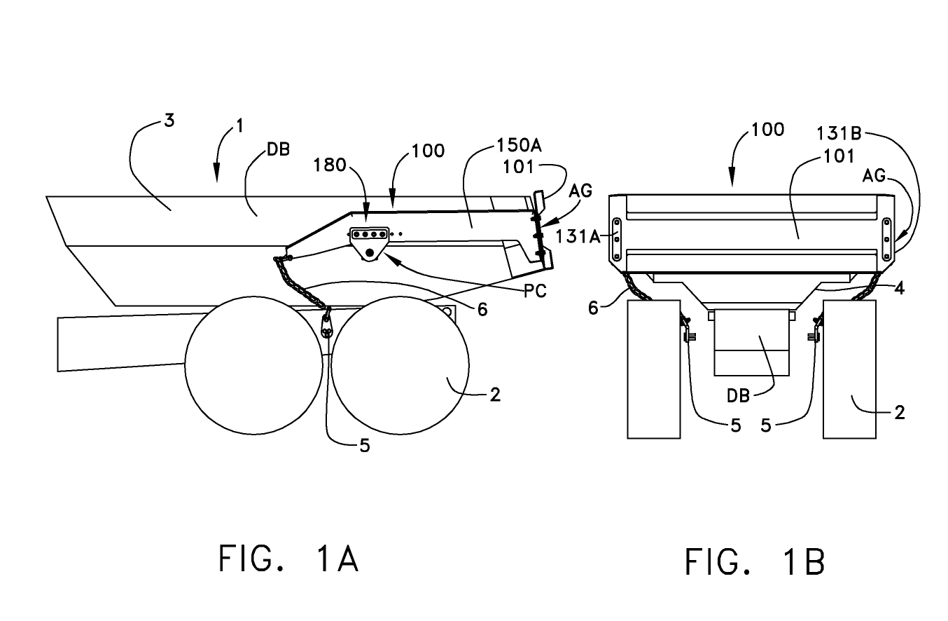

Referring now more particularly to FIGS. 1A-1B, an exemplary heavy-duty, off-road truck 1 having a truck dump body DB and universal tailgate assembly 100 constructed in accordance with the teachings of the invention is shown. The truck dump body DB includes a chassis which is supported on tires 2 and to which the truck dump body DB is attached for pivotal movement about an axis between a lowered position for receiving and transporting a load of material and a raised position for dumping the load, as is well known in the art.

In the exemplary embodiment, each opposing side of truck 1 includes one or more rear tires. In the exemplary embodiment, there is a pair of rear tires on each opposing side of the truck dump body DB. Between each pair of rear tires, the truck 1 includes a linking bracket 5. The placement of the linking bracket 5 may vary.

In the exemplary embodiment, the truck dump body DB is generally constructed of steel in the shape to carry a particular volume of material. Nonetheless, the truck dump body DB may include beams or other structures for structural support or framework. The truck dump body DB may use other metals or materials which are durable.

The truck may be a Caterpillar (CAT) 725, CAT 730, CAT 735, CAT 740 or other CAT articulated dump truck models. Alternatively, the truck may be a Volvo A25D, Volvo A25E, Volvo A35D, Volvo A35E, Volvo A40E, Volvo A40D or other Volvo dump truck models. Still further, the truck may be a John Deere, Komatsu, Case, Moxy, Bell or others dump trucks. As one of ordinary skill in the art knows, the truck may be a variety of shapes and sizes and may be manufactured by a many different manufactures. Thus, the present invention is not limited to a particular vendor or to a particular model.

The truck dump body DB comprises a pair of opposing sidewalls 3 or panels, a front wall or panel and a bed floor 4. The universal tailgate assembly 100 includes opposing sidearms 150A (only one shown in FIGS. 1A-1B) and a tailgate 101. The sidearms 150A (only one shown in FIGS. 1A-1B) are pivotally coupled to the pair of opposing sidewalls 3 via a pair of pivot connectors PC being configured to mount to the pair of opposing sidewalls 3 of the truck dump body DB. In other words, each sidewall 3 has a pivot connector PC which includes a pivot connection assembly 180. A front-ends of the sidearms 150A (only one shown in FIGS. 1A-1B) are attached to the linking brackets 5 via respective chains 6.

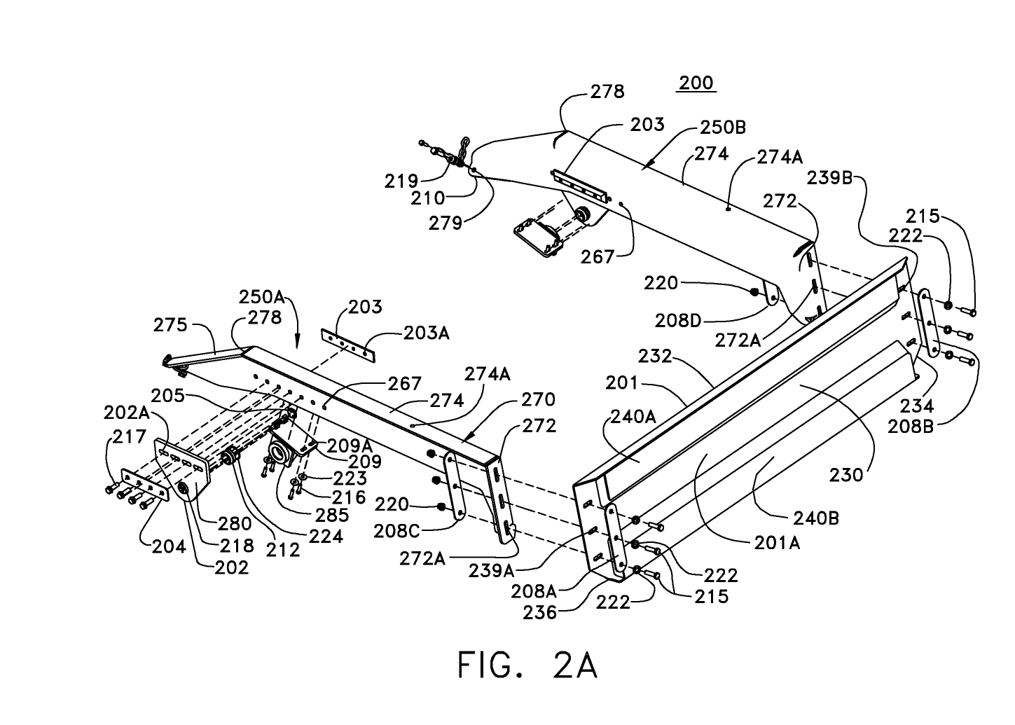

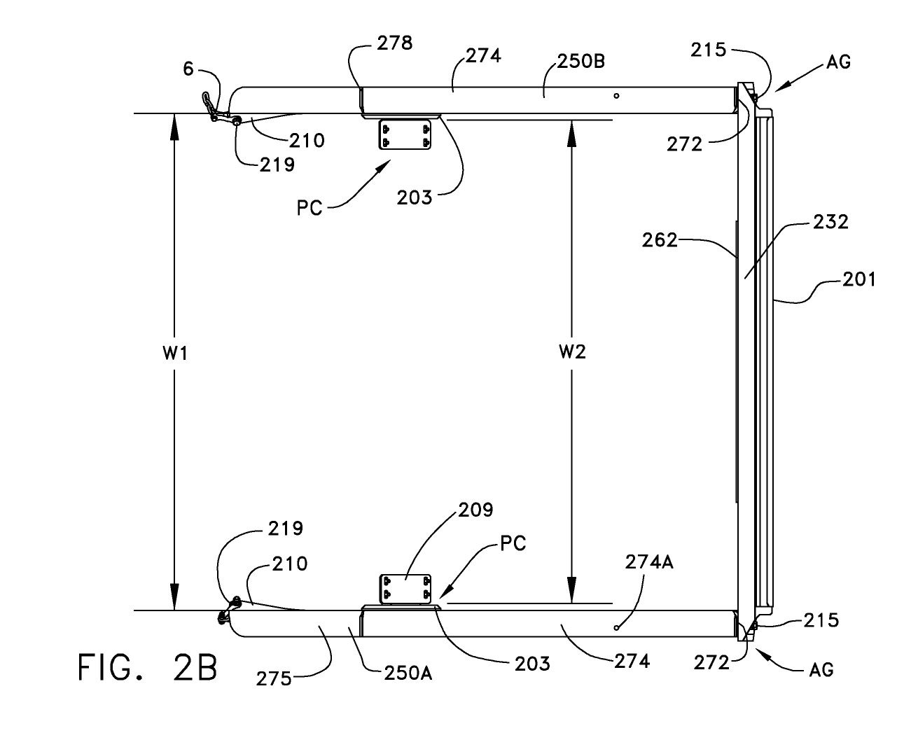

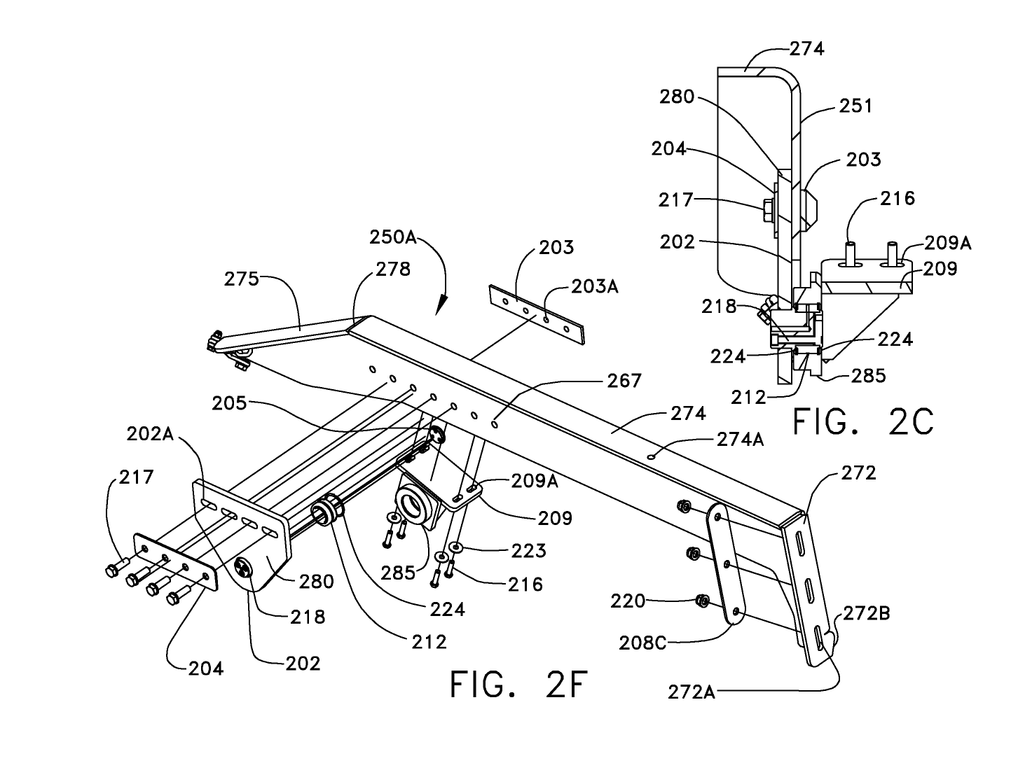

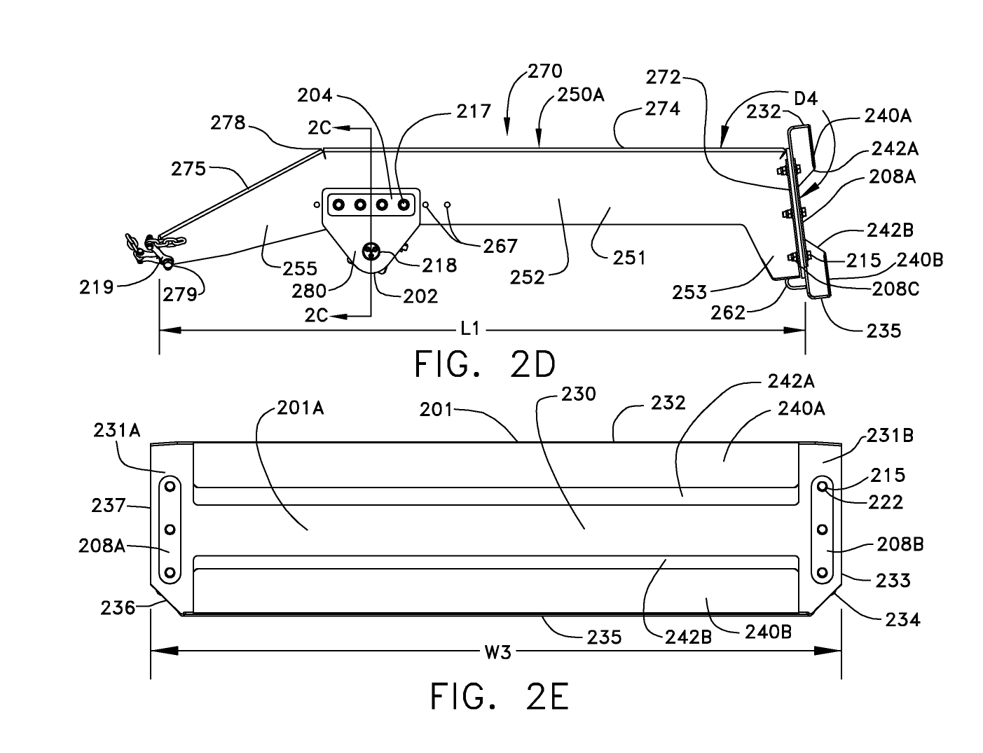

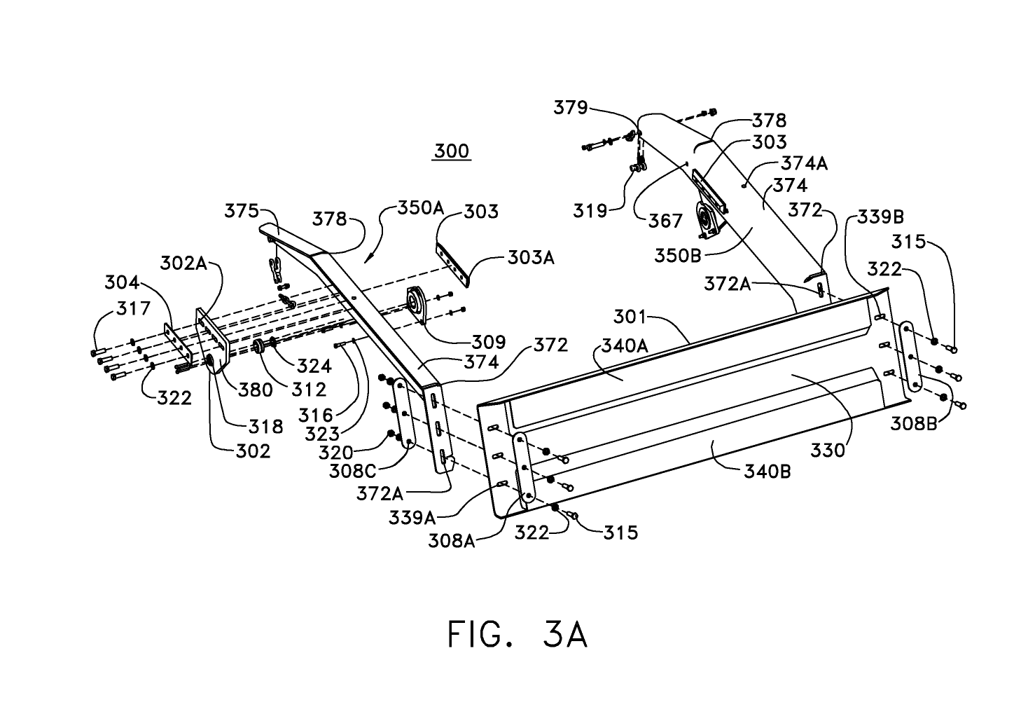

The sidearms 150A (only one shown in FIGS. 1A-1B) and tailgate 101 are configured to move in unison between a closed position and an open position. The tailgate 101 includes a center portion, as will be described in more detail in relation to FIGS. 2A, 2B and 2E, which spans substantially between the opposing sidewalls 3 of the truck dump body DB and encloses or covers an open rear-end of the truck dump body DB. The tailgate 101 includes extension sections 131A and 131B on opposing sides of the center section. The extension sections 131A and 131B provide for the arm-to-gate connection AG between the tailgate 101 and the sidearms 150A (only one shown in FIGS. 1A-1B).

The universal tailgate assembly 100 of an exemplary embodiment is configured to be adjustably attached to the truck dump body DB. Specifically, the universal tailgate assembly 100 is configured with a plurality of directions of adjustment, as will be described in detail herein. In accordance with some exemplary embodiment, the universal tailgate assembly 100 is configured with three directions of adjustment, each direction adjustable within a range.

The universal tailgate assembly 100 may be configured with an up-down (vertical) direction of adjustment in the arm-to-gate connection AG. The up-down direction of adjustment is adjustable within a range. The universal tailgate assembly 100 may be configured with a width (direction) adjustment in the arm-to-gate connection AG. The width adjustment is adjustable within a range. The universal tailgate assembly 100 may be configured with a horizontal direction of adjustment at the pivot connection PC between each sidearm 150A the truck dump body DB. The horizontal direction of adjustment is adjustable within a range.

The material of the universal tailgate assembly 100 may include metal, man-made metals, composite metals, natural metals, or a combination of one or more metals or other strong and durable materials.

The directions of adjustment include a plurality of slotted adjustments. In an exemplary embodiment, the tailgate 101 of the universal tailgate assembly 100 may be connected to the sidearms using an Angled Bracket design or configuration for the arm-to-gate connection AG. The Angled Bracket design or configuration includes a plurality of slots or variable dimensionality connectors configured to provide at least two directions of adjustment which provide up-down (vertical) adjustment and width adjustment between sidearms.

In an exemplary embodiment, the tailgate 101 may include includes a non-angled bracket design configured to provide at least two axes (directions) of adjustment using a plurality of slots or variable dimensionality connectors. A third axis or direction of adjustment may be achieved with a pivot bolted on through the slots or other variable dimensionality connectors. An optional pivot attachment may be applied using a bolt on with slots or weld on attachment methods.

In an exemplary embodiment, a front-end section (e.g., front-end section 255 in FIG. 2D) of each sidearm has a downwardly sloped profile. In other words, the front-end section has top and bottom edges or edge and flange which are angled downward. The distal end of the front-end section has a mechanism for attaching a chain 6 or cable thereto. The sloped profile lowers the chain 6 or cable attachment. While not wishing to be bound by theory, the lower attachment point may make the universal tailgate assembly design more stable and may reduce rubbing of chain 6 or cable against the truck dump body DB or other structures in the area of the sidearms. The “front-end” as described herein is the end farthest from the tailgate 101. The width of the truck dump body DB tapers in the direction toward the ground. In some instances, the truck dump body DB tapers in steps. The attachment point may be at a location on the dumb body DB which has a reduced width in comparison to the width at the top of the dump body DB. The reduction in width can be seen in FIG. 1B. Therefore, the chain 6 or cable is not in direct contact with the sides of the truck dump body DB.

FIG. 2A illustrates an exploded view of the universal tailgate assembly 200 in accordance with some exemplary embodiments of the invention. FIGS. 2B, 2D and 2E are top, side and rear views of the universal tailgate assembly of FIG. 2A. FIG. 2F illustrates an exploded view of the sidearm of FIG. 2A. In the description below, the same reference numerals in FIGS. 2A-2F are used for like parts.

The universal tailgate assembly 200 includes a pair of laterally-spaced, parallel sidearms, denoted by the numerals 250A and 250B, configured to be pivotally attached to the sidewalls of the truck dump body DB (FIGS. 1A-1B) or other portion of the truck dump body DB. The universal tailgate assembly 200 includes a rear tailgate 201 configured to be coupled to the parallel sidearms 250A and 250B of the universal tailgate assembly 200. The sidearms 250A and 250B may be sized and used with various makes and models for a variety of truck manufacturers.

In an exemplary embodiment, parallel sidearms 250A and 250B have a Bent Flange Arm configuration. The sidearms 250A and 250B may use a thinner material with the bent flanges creating stiffness and decreasing bending. The bent flanges 270 may be created by bending the material of the sidearm to approximately 90° away from the truck dump body DB or weld flange sections to a top edge of a sidearm plate 251.

Each sidearm 250A and 250B is pivotally connected to a respective one of the sidewalls 3 of the truck dump body DB by a pivot connection assembly 280 so as to allow the sidearms 250A and 250B to rotate relative to the truck dump body DB between a closed position and an open position. In the closed or non-raised position, the universal tailgate assembly 200 is in a lowered position, as best seen in FIGS. 1A and 1B. Since each sidearm is essentially the same, only one such sidearm 250A will be described in detail.

Each sidearm 250A includes a sidearm plate 251 with a top bent flange 270 having top flange portions 274 and 275 positioned approximately at 90° with respect to the sidearm plate 251. The sidearm plate 251 is elongated and has a central section 252, a rear-end section 253 and a front-end section 255. The central section 252, rear-end section 253 and front-end section 255 are integrated into a single elongated sidearm plate 251. The pivot connection assembly 280 can be positioned immediately before and immediately after angle point 278 associated with the angling of the front-end section 255 and on the central section 252.

The top flange portion 274 may include aperture 274A to attach a hook such as for lifting the sidearm 250A or 250B or universal tailgate assembly 200 via a crane or other industrial machinery.

The rear-end section 253 of the sidearm 250A has a rear vertical edge having a rear-end flange 272 extending approximately 90° in a direction opposite that of the truck dump body DB. The rear-end flange 272 has a plurality of holes, apertures, or slots 272A for fastening the tailgate 201 to the sidearm 250A via one or more fastener members 215, 220 and 222. The fasteners 215, 220 and 222 represent a bolt, washer and nut, respectively. The bolt may be a hexagonal head bolt. Nonetheless, other fastener members may be used.

The rear-end flange 272 may be created by extending the length of the sidearm 250A and bending the sidearm plate 251 of the sidearm 250A approximately 90° in a direction which is away from the truck dump body DB (FIG. 1A-1B). Alternately, the rear-end flange 272 may be created by adding a flange section to the vertical rear edge of the sidearm 250A by welding such section to the vertical rear edge.

In an exemplary embodiment, the slots 272A, holes or apertures of the rear-end flange 272 are elongated in one of a vertical plane, horizontal plane or a combination of a vertical and horizontal planes. The term “rear-end” is a proximity descriptor defined to be the closest or in proximity to the tailgate 201.

In the exemplary configuration, the rear-end section 253 of sidearm plate 251 has a boot shape or L-shape profile. The rear-end section 253 of the sidearm plate 251 has a rear-end edge having an angled profile. The rear-end edge is angled, denoted by angle D4, with respect to the top flange 270. The exterior flange angle D4 is approximately 263 degrees measured between the rear-end flange 272 and top flange portion 274. Thus, the interior flange angle is approximately 97 degrees measured interiorly between the rear-end flange 272 and the top flange portion 274.

The sidearm plate 251 includes a front-end section 255 having a downwardly sloped and tapered profile. The front-end section 255 is both sloped downwardly and gradually tapers. The front-end section 255 includes a top flange portion 275 which is joined to the top flange portions 274 at angle point 278. Angle point 278 is the point in which the top flange portion 274 begins to slope downward.

In an exemplary embodiment, a front-end section 255 has top and bottom edges or edge and flange which are angled downward. The distal end of the front-end section 255 is angled in the direction of the truck dump body DB to form a connection pad 210, as best seen in FIG. 2B. Connection pad 210 has an aperture 279 to which an attachment mechanism 219 is attached for connection to a chain 6 or cable. The attachment mechanism 219 may include a link for removably attaching the chain 6. The sloped profile lowers the chain 6 or cable attachment. While not wishing to be bound by theory, the lower attachment point (e.g., pad 210) may make the universal tailgate assembly design more stable, and may reduce rubbing of chain 6 or cable against the truck dump body DB or other structures in the area of the sidearms.

As seen in FIG. 2B, the width W1 is measured from sidearm plate 251 of sidearm 250A to the sidearm plate of sidearm 250B. Width W2 is measured essentially from the exterior side of nut bar 203 of sidearm 250A to nut bar 203 of sidearm 250B. Width W1 may be 2828 mm (millimeters) for a Caterpillar 725 truck. Width W1 may be 2958 mm for a Caterpillar 730 truck. Width W1 may be 3506 mm for a Caterpillar 740 truck. The width W2 would be adjusted according to the dimensions of Caterpillar 730, 740 or other trucks. For example, width W2 for a Caterpillar 725 truck may be 2752 mm.

In FIG. 2D, the length L1 of sidearm 250A from end-to-end is approximately 2973 mm (millimeters) for the Caterpillar 725, 730 and 740 trucks with an interior 97 degree angle between flange 272 and top flange portion 274. The length may vary slightly by truck model and/or by truck make. In addition, dents and other deformations of the rear end may require a slight adjustment in the length.

In an exemplary embodiment, the rear-end of the sidearm plate 251 is slanted in a vertical plane but may be vertical such as required for the configuration of the rear-end of the truck dump body DB.

The sidearms 250A, 250B have a one-piece construction. In an exemplary embodiment, the flanges are bent outward vertically and horizontally away from the truck dump body DB so as to define respective connection surfaces to which the tailgate 201 can be mounted, selectively positioned and/or attached.

In the exemplary embodiment, the universal tailgate assembly 200 includes a pivot connection PC (FIGS. 1A-1B) to the truck dump body DB, the pivot connection includes a pivot connection assembly 280, for each sidearm 250A, 250B, configured to be attached to the truck dump body DB. The pivot connection PC is adjustable, as will be described in detail.

The pivot connection assembly 280 for each sidearm 250A and 250B is essentially identical. Thus, only one pivot connection assembly 280 will be discussed in detail. The pivot connection assembly 280 is horizontally adjustable along a length of sidearm 250A. Specifically, the pivot connection assembly 280 is removable and directionally adjustable along a horizontal plane of the sidearm 250A. The sidearm 250A includes a plurality of holes 267, apertures or slots horizontally spaced along a first plane or a horizontal plane wherein a selective subset of the holes 267, apertures or slots are used to couple the pivot connection assembly 280 to the sidearm 250A via fasteners 217.

The pivot connection assembly 280 includes a nut bar 203 and a pivot slot cover 204 to selectively position a pivot pin weldment plate 202 of the pivot connection assembly 280 to one or more of the plurality of holes 267, apertures or slots via fasteners 217, bolts, screws, etc. Nonetheless, other fastening configurations are contemplated provided the pivot connection assembly is adjustable in a horizontal plane along the sidearm. In the exemplary embodiment, there are eight (8) holes 267. The pivot slot cover 204 has four (4) holes. Therefore, the assembly 280 can be moved in a horizontal plane (front to back or back to front directions) to accommodate for the placement of the pivot connection assembly 280 for a specific truck dump body DB configuration.

The nut bar 203 includes a plurality of threaded cavities 203A into which fasteners 217 are screwed and secured. The nut bar 203 is positioned immediately adjacent to the sidearm plate 251 along an interior side. The top and bottom edges of the nut bar 203 are shown beveled, as best seen in FIG. 2C. The pivot pin weldment plate 202 is coupled to an exterior side of the sidearm plate 251. The pivot pin weldment plate 202 has a bottom end which is triangularly shaped. The top end includes a plurality of slots 202A, apertures or holes for attachment of pivot slot cover 204. The fasteners 217 are received through the pivot slot cover 204, the plurality of slots 202A, apertures or holes in the plate 202 through the plurality of holes 267, apertures or slots in sidearm plate 251 and then into the threaded cavities 203A of nut bar 203.

The pivot connection assembly 280 also includes a pivot block 209 configured to be mounted to the truck dump body DB in proximity to a sidewall 3. The pivot block 209 includes slots 209A, holes or apertures for attachment of fasteners 216 and 223 wherein fasteners 216 and 223 are bolts and nuts, respectively, for attachment to the truck dump body DB.

Referring also to FIG. 2C a cross-sectional view along the plane 2C-2C of FIG. 2D is shown. The pivot block 209 includes a pivot housing 285 having a generally hollow circular cavity. The pivot housing 285 receives a snap rings 224 and bearing 212. The snap rings 224 are on ends of bearing 212. The pivot housing 285 is closed by shaft cover plate 205. The plate 202 has a housing into which a plurality of screws 218 is mounted. In operation, the sidearm 250A is configured to pivot to and from a lowered position and a raised position via the pivot connection assembly 280.

In the open or raised position, the sidearms of the universal tailgate assembly 200 are pivoted upward, in unison, relative to the rear-end of the truck dump body DB such that the tailgate 201 is above or raised with respect to the truck dump body DB. In the open or raised position, material within the truck dump body DB may be dumped from the open rear-end of the truck dump body DB.

The tailgate 201 has a generally rectangular shape with a primary plate section 230 having two tailgate extension sections 231A and 231B configured to extend past the sidewalls of the truck dump body DB and overlap the rear-end flanges 272 of the sidearms 250A and 250B, respectively. The tailgate extension sections 231A and 231B have a plurality of slots 239A and 239B, respectively, apertures or holes which are in vertical spaced relation to align with the slots 272A, apertures or holes in the rear-end flanges 272 of each sidearm 250A, 250B.

In an exemplary embodiment, the plurality of slots 239A, 239B, apertures or holes of the tailgate extension sections 231A and 231B are elongated in one of a horizontal plane, vertical plane or a combination of a horizontal and vertical plane.

In an exemplary embodiment, the plurality of slots 239A, 239B, apertures or holes of the tailgate extension sections 231A and 231B are elongated in a first plane while the plurality of slots 272A, apertures or holes of the rear-end flange 272 are elongated in a second plane opposite the first plane. The first plane is horizontal while the second plane is vertical. The elongation in the vertical plane provides a direction of adjustment in a vertical plane. The elongation in the horizontal plane provides a direction of adjustment in a horizontal plane. The arm-to-gate connections AG (FIG. 1A-1B) include the connection of the rear-end flange 272 of sidearm 250A to the tailgate extension section 231A and the connection of the rear-end flange 272 of sidearm 250B to the tailgate extension section 231B.

With specific reference to FIG. 2D, the overall height of the tailgate 201 is longer than the overall height of the rear-end flange 272 so that the tailgate 201 can be moved up or down in relation to the rear-end flange 272 so as to orient or enhance the fit of the tailgate 201 to cover the rear-end opening of the truck dump body DB. Thus, sand, dirt or other objects transported in the truck dump body DB are not easily lost though gaps between the tailgate 201, sidearms 250A and 250B and the truck dump body DB.

In an exemplary embodiment, one or more cover plates 208A and 208C are used to fasten fasteners 215, 222 and 220 to rear-end flange 272 of sidearm 250A to the tailgate extension section 231A. One or more cover plates 208B and 208D are used to fasten fasteners 215, 222 and 220 to rear-end flange 272 of sidearm 250B to the tailgate extension section 231B.

The configuration of the primary plate section 230 with top leg 232 and bottom leg 235 form a U-shape or C-shape. Top and bottom cover plates 240A and 240B attached to top leg 232 and bottom leg 235, respectively. The cover plates 240A and 240B includes sloped surfaces 242A and 242B, respectively, which slopes back to primary plate section 230, wherein a hollow elongated cavity is formed between the cover plates 240A and 240B and the primary plate section 230. The cover plates 240A and 240B are generally parallel to the primary plate section 230. However, sloped surfaces 242A and 242B are sloped in the direction of the primary plate section 230 and are affixed, coupled or welded thereto.

The cover plates 240A and 240B included end panels or surfaces to enclose the gap between cover plates 240A and 240B, sloped surfaces 242A and 242B and primary plate section 230 so that there is an appearance of a solid bar. However, the interior is hollow to reduce material and/or weight. Nonetheless, a solid bar may be used. Generally, the center section 201A of the tailgate 201 includes the length of cover plates 240A and 240B across the tailgate 201.

The C-shape configuration provides that the top leg 232 and bottom leg 235 are oriented in a direction which is away from the truck dump body DB (FIG. 1A). The top leg 232 extends generally from end to end of the tailgate 201. However, the bottom leg 235 and a portion of the primary plate section 230 are truncated such that the bottom corners 234 and 236 of the tailgate 201 appear truncated.

When the tailgate 201 is attached to the truck dump body DB, the bottom leg 235 and a portion of the primary plate section 230 extend below a bottom end of the rear-end opening of the truck dump body DB so that there is an overhang, as best seen in FIG. 2D. A stop or rest 262 is affixed behind the primary plate section 230 and is positioned below the rear-end section 253 of each sidearm 250A and 250B. In operation, when the tailgate 201 is lowered, the stop or rest 262 may engage the floor of the truck dump body DB.

The tailgate extension sections 231A and 231B include that portion of the primary plate section 230 of tailgate 201 which lies beyond the opening between the sidewalls of the truck dump body DB. For example, the tailgate extension sections 231A and 231B may include that portion of the primary plate section corresponding to the area having the truncated corners 236 and 234, respectively. The tailgate extension sections 231A and 231B may include that portion of the primary plate section not covered by cover plates 240A and 240B, respectively.

The tailgate 201 includes a top end having a first thickness, a bottom end having a second thickness and a center strip having a third thickness. The top end and bottom end may have the same thickness. The top end and the second end may have sloped surface toward the center strip. In the exemplary embodiment, the extension sections may have the third thickness.

In the exemplary embodiment, the first thickness is substantially equal to the second thickness. The third thickness being less than the first and second thicknesses.

The center section 201A spans across substantially the entire width of the open rear-end of the truck dump body DB.

The exemplary embodiments of FIGS. 2A-2F may be used with a Caterpillar 725 (CAT 725). However, the concepts described herein may be adapted for other articulated dump truck designs as well as for non-articulated dump truck designs. The width W3 of FIG. 2E is measured essentially from opposing vertical edges 233 and 237 of the tailgate 201. Width W3 may be 3178 mm for a Caterpillar 725 truck. Width W3 may be 3308 mm for a Caterpillar 730 truck. Width W3 may be 3856 mm for a Caterpillar 740 truck. The measurements are for illustrative purposes and may be adapted for other truck manufacturers by make and by model.

In an exemplary embodiment, a bottom interior corner 272B (FIG. 2F) of the flange 272 is beveled or sloped in a direction which is away from or opposite the direction of the truck dump body DB so as to prevent snagging or catching on obstructions, or imperfection in the truck dump body DB.

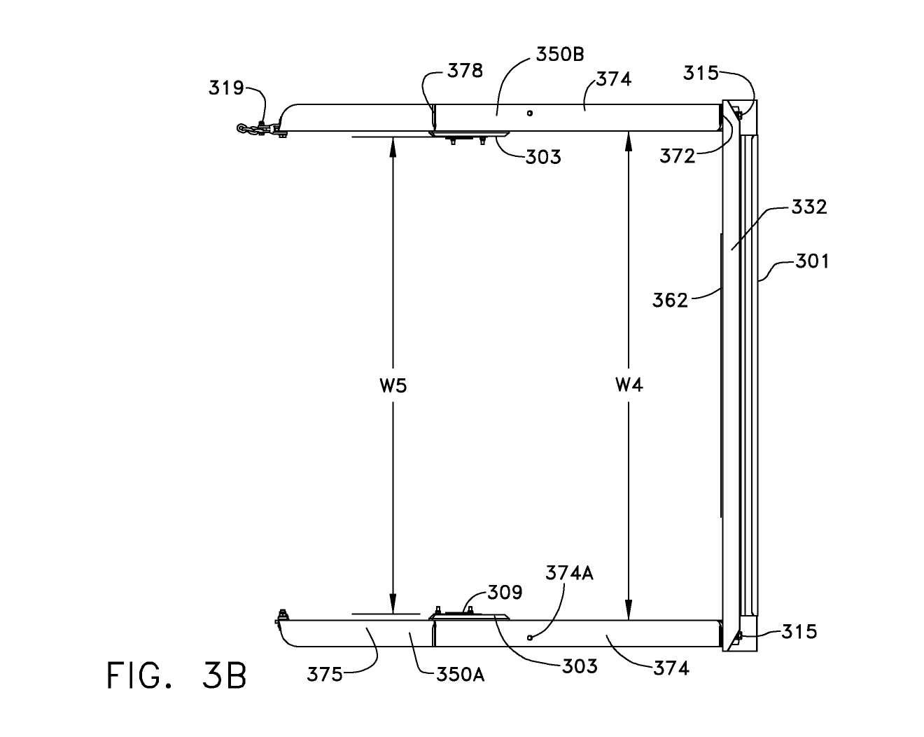

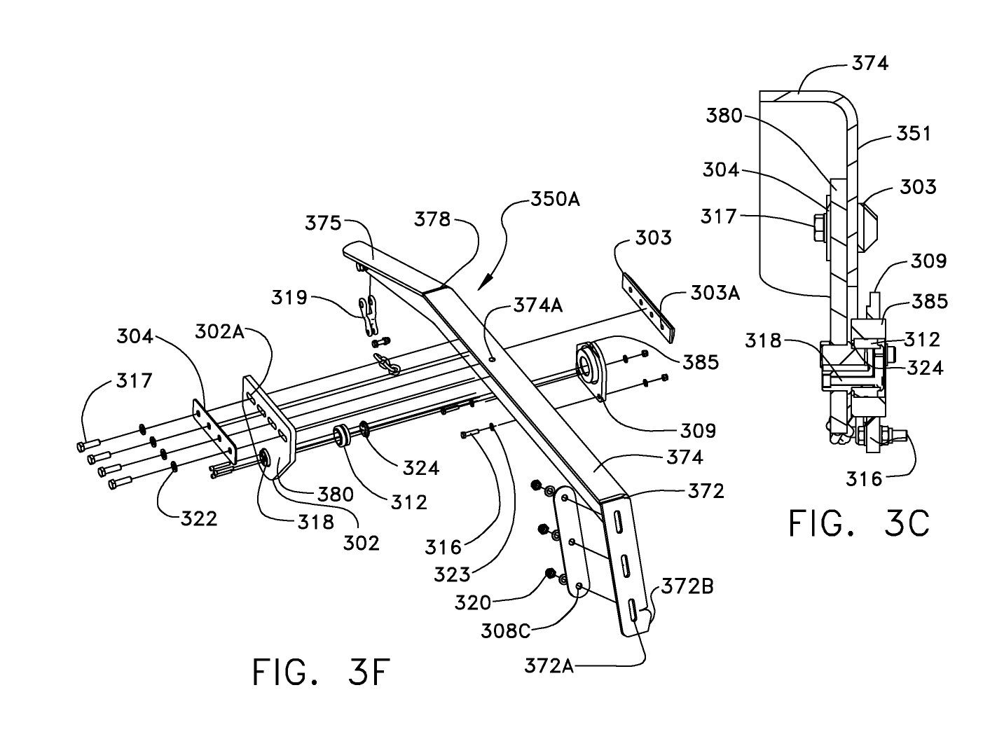

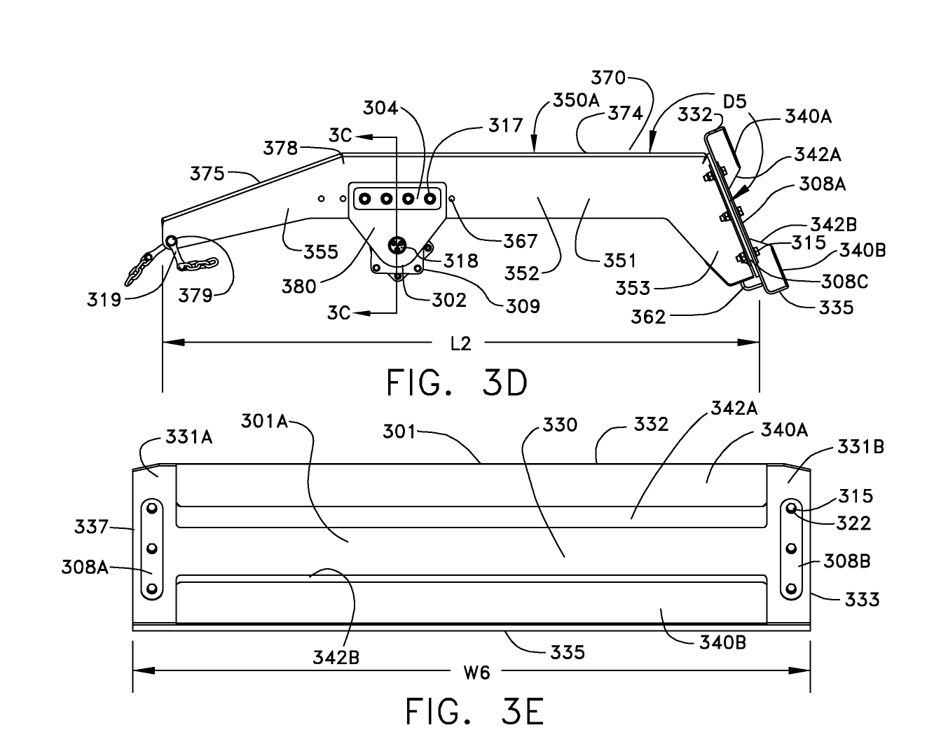

FIG. 3A illustrates an exploded view of the universal tailgate assembly 300 in accordance with some exemplary embodiments of the invention. FIGS. 3B, 3D and 3E are top, side and rear views of the universal tailgate assembly of FIG. 3A. FIG. 3F illustrates an exploded view of the sidearm of FIG. 3A. In the description below, the same reference numerals in FIGS. 3A-3F are used for like parts. The embodiment of FIGS. 3A-3F may be used for a Volvo A25D truck, Volvo A25E truck, Volvo A35D truck, Volvo A35E truck, Volvo A40D truck, Volvo A40E truck or other Volvo articulated dump truck models.

The universal tailgate assembly 300 is similar to the universal tailgate assembly 200. However, the differences are noted below in the description. The differences include the flange angle, pivot connection assembly, front-end section of the sidearm plate 351 and tailgate 301.

The universal tailgate assembly 300 includes a pair of laterally-spaced, parallel sidearms, denoted by the numerals 350A and 350B, configured to be pivotally attached to the sidewalls of the truck dump body DB (FIGS. 1A-1B) or other portion of the truck dump body DB. The universal tailgate assembly 300 includes a rear tailgate 301 configured to be coupled to the parallel sidearms 350A and 350B of the universal tailgate assembly 300.

In an exemplary embodiment, parallel sidearms 350A and 350B have a Bent Flange Arm configuration. The sidearms 350A and 350B may use a thinner material with the bent flanges creating stiffness and decreasing bending. The bent flanges 370 may be created by bending the material of the sidearm to approximately 90° away from the truck dump body DB or weld flange sections to a top edge of a sidearm plate 351.

Each sidearm 350A and 350B is pivotally connected to a respective one of the sidewalls 3 of the truck dump body DB by a pivot connection assembly 380 so as to allow the sidearms 350A and 350B to rotate relative to the truck dump body DB between a closed position and an open position. In the closed or non-raised position, the universal tailgate assembly 300 is in a lowered position, as best seen in FIGS. 1A and 1B. Since each sidearm is essentially the same, only one such sidearm 350A will be described in detail.

Each sidearm 350A includes a sidearm plate 351 with a top bent flange 370 having top flange portions 374 and 375 positioned approximately at 90° with respect to the sidearm plate 351. The sidearm plate 351 is elongated and has a central section 352, a rear section 353 and a front-end section 355. The central section 352, rear-end section 353 and front-end section 355 are integrated into a single elongated sidearm plate 351. The pivot connection assembly 380 is positioned immediately before the front-end section 355 and on the central section 352.

The top flange portion 374 may include aperture 374A to attach a hook such as for lifting the sidearm 350A or 350B or universal tailgate assembly 300 via a crane or other industrial machinery.

The rear-end section 353 of the sidearm 350A has a rear vertical edge having a rear-end flange 372 extending approximately 90° in a direction opposite that of the truck dump body DB. The rear-end flange 372 has a plurality of holes, apertures, or slots 372A for fastening the tailgate 301 to the sidearm 350A via one or more fastener members 315, 320 and 322. The fasteners 315, 320 and 322 represent a bolt, washer and nut, respectively. The bolt may be a hexagonal head bolt. Nonetheless, other fastener members may be used.

The rear-end flange 372 may be created by extending the length of the sidearm 350A and bending the sidearm plate 351 of the sidearm 350A approximately 90° in a direction which is away from the truck dump body DB (FIG. 1A-1B). Alternately, the rear-end flange 372 may be created by adding a flange section to the vertical rear edge of the sidearm 350A by welding such section to the vertical rear edge.

In an exemplary embodiment, the slots 372A, holes or apertures of the rear-end flange 372 are elongated in one of a vertical plane, horizontal plane or a combination of a vertical and horizontal planes. The term “rear-end” is a proximity descriptor defined to be the closest or in proximity to the tailgate 301.

In the exemplary configuration, the rear-end section 353 of sidearm plate 351 has a boot shape or L-shape profile. The rear-end section 353 of the sidearm plate 351 has a rear-end edge having an angled profile. The rear-end edge is angled, denoted by angle D5, with respect to the top flange 370. The exterior flange angle D4 is approximately 248 degrees. More specifically, the interior angle between the rear-end flange 372 and top flange portion 374 is approximately 112 degrees.

The sidearm plate 351 includes a front-end section 355 having a downwardly sloped and tapered profile. The front-end section 355 is both sloped downwardly and gradually tapers. The front-end section 355 includes a top flange portion 375 which is joined to the top flange portions 374 at angle point 378. Angle point 378 is the point in which the top flange portion 374 begins to slope downward.

In an exemplary embodiment, a front-end section 355 has top and bottom edges or edge and flange which are angled downward. Unlike the embodiment of FIGS. 2A-2F, the distal end of the front-end section 355 does not include a connection pad. Instead, the front-end section 355 includes an aperture 379 to which an attachment mechanism 319 is attached for connection to a chain 6 or cable. The attachment mechanism 319 may include a link for removably attaching the chain 6. The sloped profile lowers the chain 6 or cable attachment. While not wishing to be bound by theory, the lower attachment point may make the universal tailgate assembly 300 design more stable, and may reduce rubbing of chain 6 or cable against the truck dump body DB or other structures in the area of the sidearms.

As seen in FIG. 3B, the width W4 is measured from sidearm plate 351 of sidearm 350A to the sidearm plate of sidearm 350B. Width W5 is measured essentially from the exterior side of nut bar 303 of sidearm 350A to nut bar 303 of sidearm 350B. Width W4 may be 2768 mm (millimeters) for a Volvo A25E truck and 3441 mm for a Volvo A40E. The width W5 may be 3373 for the Volvo A40E truck and 2700 for the Volvo A25E truck. The dimensions of width W4 and width W5 may vary for different Volvo articulated dump truck models and for other dump truck models. In addition, dents and other deformations of the rear end may require a slight adjustment in the length.

In FIG. 3D, the length L2 of sidearm 350A from end-to-end is approximately 2747 mm (millimeters) for the Volvo A25E and A40E trucks with an interior 112 degree angle between flange 372 and top flange portion 374.

In an exemplary embodiment, the rear-end of the sidearm plate 351 is slanted in a vertical plane but may be vertical such as required for the configuration of the rear-end of the truck dump body DB.

The sidearms 350A, 350B have a one-piece construction. In an exemplary embodiment, the flanges are bent outward vertically and horizontally away from the truck dump body DB so as to define respective connection surfaces to which the tailgate 301 can be mounted, selectively positioned and/or attached.

In the exemplary embodiment, the universal tailgate assembly 300 includes a pivot connection PC (FIGS. 1A-1B) to the truck dump body DB, the pivot connection includes a pivot connection assembly 380, for each sidearm 350A, 350B, configured to be attached to the truck dump body DB. The pivot connection PC is adjustable, as will be described in detail.

The pivot connection assembly 380 for each sidearm 350A and 350B is essentially identical. Thus, only one pivot connection assembly 380 will be discussed in detail. The pivot connection assembly 380 is horizontally adjustable along a length of sidearm 350A. Specifically, the pivot connection assembly 380 is removable and directionally adjustable along a horizontal plane of the sidearm 350A. The sidearm 350A includes a plurality of holes 367, apertures or slots horizontally spaced along a first plane or a horizontal plane wherein a selective subset of the holes 367, apertures or slots are used to couple the pivot connection assembly 380 to the sidearm 350A via fasteners 317 and 322.

The pivot connection assembly 380 includes a nut bar 303 and a pivot slot cover 304 to selectively position a pivot pin weldment plate 302 of the pivot connection assembly 380 to one or more of the plurality of holes 367, apertures or slots via fasteners 317, bolts, screws, etc. Nonetheless, other fastening configurations are contemplated provided the pivot connection assembly is adjustable in a horizontal plane along the sidearm.

The nut bar 303 includes a plurality of threaded cavities 303A into which fasteners 317 are screwed and secured. The nut bar 303 is positioned immediately adjacent to the sidearm plate 351 along an interior side. The top and bottom edges of the nut bar 303 are shown beveled in FIG. 3C. The pivot pin weldment plate 302 is coupled to an exterior side of the sidearm plate 351. The pivot pin weldment plate 302 has a bottom end which is triangularly shaped. The top end includes a plurality of slots 302A, apertures or holes for attachment of pivot slot cover 304. The fasteners 317 are received through the pivot slot cover 304, the plurality of slots 302A, apertures or holes in the plate 302 through the plurality of holes 367, apertures or slots in sidearm plate 351 and then into the threaded cavities 303A of nut bar 303.

The pivot connection assembly 380 also includes a pivot plate 309 configured to be affixed to plate 302 mounted to the truck dump body DB in proximity to a sidewall 3. The pivot block 209 of FIG. 2A has been replaced with a pivot plate 309. The pivot plate 309 includes slots, holes or apertures for attachment of fasteners 316 and 323 wherein fasteners 316 and 323 are bolts and nuts, respectively, for attachment to the truck dump body DB.

Referring also to FIG. 3C a cross-sectional view along the plane 3C-3C of FIG. 3D is shown. The pivot plate 309 includes a pivot housing 385 having a generally hollow circular cavity. The pivot housing 385 receives a snap rings 324 and bearing 312. The snap rings 324 are on ends of bearing 312. The plate 302 has a housing into which a plurality of screws 318 is mounted. In operation, the sidearm 350A is configured to pivot to and from a lowered position and a raised position via the pivot connection assembly 380.

In the open or raised position, the sidearms of the universal tailgate assembly 300 are pivoted, in unison, upward relative to the rear-end of the truck dump body DB such that the tailgate 301 is above or raised with respect to the truck dump body DB. In the open or raised position, material within the truck dump body DB may be dumped from the open rear-end of the truck dump body DB.

The tailgate 301 has a generally rectangularly-shaped with a primary plate section 330 having two tailgate extension sections 331A and 331B configured to extend past the sidewalls of the truck dump body DB and overlap the rear-end flanges 372 of the sidearms 350A and 350B, respectively. The tailgate extension sections 331A and 331B have a plurality of slots 339A and 339B, respectively, apertures or holes which are in vertical spaced relation to align with the slots 372A, apertures or holes in the rear-end flanges 372 of each sidearm 350A, 350B.

In an exemplary embodiment, the plurality of slots 339A, 339B, apertures or holes of the tailgate extension sections 331A and 331B are elongated in one of a horizontal plane, vertical plane or a combination of a horizontal and vertical plane.

In an exemplary embodiment, the plurality of slots 339A, 339B, apertures or holes of the tailgate extension sections 331A and 331B are elongated in a first plane while the plurality of slots 372A, apertures or holes of the rear-end flange 372 are elongated in a second plane opposite the first plane. The first plane is horizontal while the second plane is vertical. The elongation in the vertical plane provides a direction of adjustment in a vertical plane. The elongation in the horizontal plane provides a direction of adjustment in a horizontal plane. The arm-to-gate connections AG (FIG. 1A-1B) includes the connection of the rear-end flange 372 of sidearm 350A to the tailgate extension section 331A and the connection of the rear-end flange 372 of sidearm 350B to the tailgate extension section 331B.

In an exemplary embodiment, one or more cover plates 308A and 308C are used to fasten fasteners 315, 322 and 320 to rear-end flange 372 of sidearm 350A to the tailgate extension section 331A. One or more cover plates (only plate 308B shown) are used to fasten fasteners 315, 322 and 320 to rear-end flange 372 of sidearm 350B to the tailgate extension section 331B.

The primary plate section 330 has a top leg 332 and a bottom leg 335 forming a U-shape or C-shape. Top and bottom cover plates 340A and 340B attached to top leg 332 and bottom leg 335, respectively. The cover plates 340A and 340B includes sloped surfaces 342A and 342B, respectively, which slopes back to primary plate section 330, wherein a hollow elongated cavity is formed between the cover plates 340A and 340B and the primary plate section 330. The cover plates 340A and 340B are generally parallel to the primary plate section 330. However, sloped surfaces 342A and 342B are sloped in the direction of the primary plate section 330 and are affixed, coupled or welded thereto.

The cover plates 340A and 340B included end panels or surfaces to enclose the gap between cover plates 340A and 340B, sloped surfaces 342A and 342B and primary plate section 330 so that there is an appearance of a solid bar. However, the interior is hollow to reduce material and/or weight. Nonetheless, a solid bar may be used. Generally, the center section 301A of the tailgate 301 includes the length of cover plates 340A and 340B across the tailgate 301.

The top leg 332 and bottom leg 335 are oriented in a direction which is away from the truck dump body DB (FIG. 1A). The top leg 332 extends generally from end to end of the tailgate 301. However, the bottom leg 335 and a portion of the primary plate section 330 are not truncated such as the bottom corners, as shown in the embodiment of FIG. 2E.

When the tailgate 301 is attached to the truck dump body DB, the bottom leg 335 and a portion of the primary plate section 330 extend below a bottom end of the rear-end opening of the truck dump body DB so that there is an overhang, as seen in FIG. 3D. A stop or rest 362 is affixed behind the primary plate section 330 and is positioned below the rear-end section 353 of each sidearm 350A and 350B. In operation, when the tailgate 301 is lowered, the stop or rest 362 may engage the floor of the truck dump body DB.

The tailgate extension sections 331A and 331B include that portion of the primary plate section 330 of tailgate 301 which lies beyond the opening between the sidewalls of the truck dump body DB. The tailgate extension sections 331A and 331B may include that portion of the primary plate section not covered by cover plates 340A and 340B, respectively. The tailgate 301 does not have bottom truncated corners.

The tailgate 301 includes a top end having a first thickness, a bottom end having a second thickness and a center strip having a third thickness. The top end and bottom end may have the same thickness. The top end and the second end may have sloped surface toward the center strip. In the exemplary embodiment, the extension sections may have the third thickness.

In the exemplary embodiment, the first thickness is substantially equal to the second thickness. The third thickness being less than the first and second thicknesses.

The center section 301A spans across substantially the entire width of the open rear-end of the truck dump body DB.

The width W6 of FIG. 3E is measured essentially from opposing vertical edges 333 and 337 of the tailgate 301. Width W6 may be 3118 mm for a Volvo A25E truck and 3791 for a Volvo A40E truck. The dimensions may vary for other Volvo articulated dump truck models and for non-articulated dump trucks.

In an exemplary embodiment, a bottom interior corner 372B (FIG. 3F) of the flange 372 is beveled or sloped in a direction which is away from or opposite the direction of the truck dump body DB so as to prevent snagging or catching on obstructions, or imperfection in the truck dump body DB.

In view of the foregoing, a Flat Arm version may be provided that would require a thick plate of material for stiffness.

In view of the foregoing, a Bent flange arm version may be provided. In the Bent flange arm version, a thinner plate of material may be used wherein the bent flanges create stiffness and decrease bending. As an alternative, the flanges can be welded instead of being bent.

In view of the foregoing, various slotted adjustments are contemplated for direction adjustments. For example, the Angled flange (e.g., flanges 272 or 372) provides a bracket design that gives at least two axes or directions of adjustment; up down adjustment and width adjustment between arms. Non-angle bracket design gives two axes of adjustment, but could have a third if a pivot is bolted on through slots

Optional pivot attachment methods may include bolt on with slots or weld on.

In view of the foregoing, the sidearm design is compatible with both the 25 ton and 40 ton trucks. However, in order to retrofit these two different designs, the pivot position needed to be different by a few inches. Thus, the pivot connection assembly is adjustable in the horizontal plane.

In an exemplary embodiment, the sidearms of the universal tailgate assembly may have a Flat Arm configuration with 3-Dimensional Adjustment. The Flat Arm configuration may include a thicker plate of material for stiffness.

The measurements provided herein are estimates and may vary. The dimensions described above for the universal tailgate assembly may be used for trucks of a variety of dimensions. The tailgate assembly can be used on old and used trucks having may dents and other imperfections as the result of use. These imperfections can vary the dimensions of the truck model. The universal properties allow the tailgate assembly to fit many trucks.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A universal tailgate assembly for a truck dump body having a pair of opposing sidewalls and an open rear-end, the universal tailgate assembly comprising:
a pair of pivot connector assemblies being configured to mount to the sidewalls of the truck dump body;
a pair of opposing sidearms configured to adjustably couple thereto the pair of pivot connector assemblies and each sidearm includes a connection flange oriented in a direction opposite a respective adjacent sidewall of the truck dump body; and
a tailgate supported by the pair of opposing sidearms, the tailgate having a center portion and extension sections on opposing sides of the center portion, a respective one extension section being adjustably coupled to and overlapping the connection flange of a corresponding sidearm wherein the extension sections extend beyond the sidewalls of the truck dump body.

2. The assembly according to claim 1, wherein the pair of opposing sidearms and the tailgate are configured to move in unison between a closed position and an open position; and the center portion of the tailgate spans substantially between the opposing sidewalls of the truck dump body and closes the open rear-end of the truck dump body.

3. The assembly according to claim 1, wherein the universal tailgate assembly is configured with a plurality of directions of adjustment.

4. The assembly according to claim 3, wherein there are three directions of adjustment, each direction adjustable within a range.

5. The assembly according to claim 3, wherein a first direction of adjustment comprises an up-down direction of adjustment in arm-to-gate connections between the extension sections of the tailgate and the connection flange for said each sidearm;
a second direction of adjustment is a width adjustment in the arm-to-gate connections for connection of the extension sections of the tailgate and the connection flange for said each sidearm; and
a horizontal direction of adjustment at the pair of pivot connection assemblies along the pair of opposing sidearms for attachment to the truck dump body.

6. The assembly according to claim 1, wherein the connection flange is angled and is configured to provide a plurality of directions of adjustment, the plurality of directions of adjustments include up and down adjustments and a width adjustment between the opposing sidearms in relation to positioning of the tailgate in relation to the truck dump body.

7. The assembly according to claim 1, wherein said each sidearm comprises a bent flange configuration along a top side of said each sidearm wherein the bent flange configuration creates stiffness and decreases bending.

8. The assembly according to claim 1, wherein said each sidearm includes a front-end section having a downwardly sloped profile and an attachment mechanism coupled to a low attachment point of the front-end section.

9. A universal tailgate assembly for a truck dump body having a pair of opposing sidewalls and an open rear-end, the universal tailgate assembly comprising:
a pair of sidearms pivotally mounted to the truck dump body; and
a tailgate adjustably mounted to the pair of sidearms via opposing arm-to-gate connections, the opposing arm-to-gate connections include means for adjusting the tailgate vertically in relation to the pair of sidearms and means for adjusting a width between the opposing arm-to-gate connections for connection of the tailgate to the pair of sidearms in relation to the truck dump body.

10. The assembly according to claim 9, wherein the pair of sidearms and the tailgate are configured to move in unison between a closed position and an open position.

11. The assembly according to claim 9, wherein the tailgate comprises:
a center portion; and
extension sections on opposing sides of the center portion, a respective one extension section being adjustably coupled to and overlapping a connection flange of a corresponding sidearm wherein the extension sections extend beyond the sidewalls of the truck dump body.

12. The assembly according to claim 11, wherein the center portion of the tailgate spans substantially between the opposing sidewalls of the truck dump body and closes the open rear-end of the truck dump body.

13. The assembly according to claim 9, further comprising:
a pair of pivot connector assemblies being configured to mount to the sidewalls of the truck dump body wherein the pair of sidearms are configured to adjustably couple thereto the pair of pivot connector assemblies, and a pivot connector assembly comprises a means for horizontally adjusting said pivot connection assembly along a horizontal plane of a respective one sidearm.

14. The assembly according to claim 9, wherein each sidearm comprises a bent flange configuration along a top side of said each sidearm wherein the bent flange configuration creates stiffness and decreases bending and is bent in a direction away from the truck dump body.

15. The assembly according to claim 14, wherein said each sidearm comprises a top connection flange and a rear-end connection flange, the rear-end connection flange is in proximity to the tailgate and angled and wherein an arm-to-gate connection includes a connection of the rear-end connection flange to a corresponding tailgate extension section of the tailgate.

16. The assembly according to claim 15, wherein said each sidearm further includes a front-end section having a downwardly sloped profile and an attachment mechanism coupled to a low attachment point of the front-end section.

17. An articulated truck comprising:
a truck having a truck dump body, the truck dump body includes a pair of opposing sidewalls and an open rear-end; and
a universal tailgate assembly comprising:
a pair of sidearms pivotally mounted to the truck dump body, and
a tailgate adjustably mounted to the pair of sidearms via opposing arm-to-gate connections, the opposing arm-to-gate connections include means for adjusting the tailgate vertically in relation to the pair of sidearms and means for adjusting a width between the opposing arm-to-gate connections for connection of the tailgate to the pair of sidearms in relation to the truck dump body.

18. The truck according to claim 17, wherein the tailgate comprises:
a center portion; and
extension sections on opposing sides of the center portion, a respective one extension section being adjustably coupled to and overlapping a connection flange of a corresponding sidearm wherein the extension sections extend beyond the sidewalls of the truck dump body.

19. The truck according to claim 18, wherein the center portion of the tailgate spans substantially between the opposing sidewalls of the truck dump body and encloses the open rear-end of the truck dump body.

20. The truck according to claim 17, further comprising:
a pair of pivot connector assemblies being configured to mount to the sidewalls of the truck dump body wherein the pair of sidearms are configured to adjustably couple thereto the pair of pivot connector assemblies, and a pivot connector assembly comprises a means for horizontally adjusting said pivot connection assembly along a horizontal plane of a respective one sidearm.
